(19) United States
(12) Patent Application Publication
(10) Pub. No.: US 2008/0100896 A1
(43) Pub. Date: May 1, 2008

(54) Moving a structure

(76) Inventors: Manish Giri, Corvallis, OR (US); Chris Bakker, Corvallis, OR (US); Joshua M. Yu, Corvallis, OR (US); Jeremy Harlan Donaldson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/589,642

(22) Filed: Oct. 30, 2006

(51) Int. Cl. G02B 26/08

(52) U.S. Cl. 359/223; 359/896

(57) ABSTRACT

Embodiments of moving a structure using a bubble are disclosed.

### BACKGROUND

In the application of MEMS devices, it may be difficult to move structural components of the MEMS device at a desired rate with relatively low power consumption.

### BRIEF DESCRIPTION OF THE DRAWINGS

FIG. 1 is a top partial view of an embodiment of an imaging device including an array of micromirrors.

FIG. 2 is an isometric view of an embodiment of an individual micromirror of the array of FIG. 1. in a rest position.

FIG. 3 is an isometric view of the embodiment of the individual micromirror of FIG. 2. in an active position.

FIG. 4 is a side cross-sectional view of the embodiment of the individual micromirror of FIG. 2 taken along cross-sectional line 4-4.

FIG. 5 is a side cross-sectional view of an embodiment of the micromirror during bubble formation.

FIG. 6 is a side cross-sectional view of an embodiment of the micromirror during imparting of bubble energy to the embodiment of the micromirror and movement of the mirror to an active position.

FIG. 7 is a side cross-sectional view of an embodiment of the micromirror during latching of the mirror to a latch device.

FIG. 8 is a side cross-sectional view of an embodiment of the micromirror during release by the latch device and movement of the mirror to a rest position.

### DETAILED DESCRIPTION OF THE DRAWINGS

The present disclosure provides an apparatus and method for actuating structures in fluid. The method can be utilized in a wide variety of applications, such as thermal ink jet devices. For ease of illustration, Applicants will discuss the present disclosure in terms of one embodiment, namely, MEMS micro mirror imaging arrays.

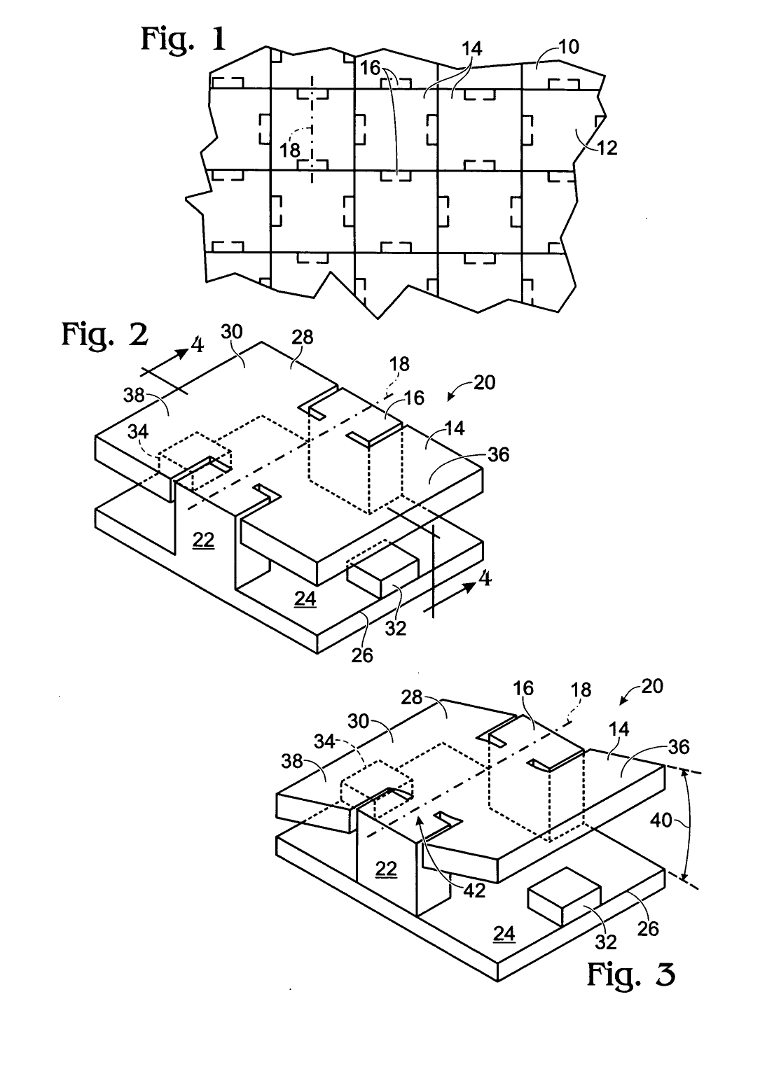

FIG. 1 is a top partial view of an imaging device 10, such as a MEMS device, including an array 12 of individual imaging structures, such as micro mirrors 14. Each micro mirror 14 includes two support regions 16 positioned across mirror 14 from one another and along a rotational axis 18 of the mirror. In other embodiments, other numbers, sizes, shapes, and types of supports or support 16 may be utilized. Support regions 16 of adjacent mirrors 14 may be positioned in an alternating ninety degree pattern within array 12 to eliminate cross-talk between adjacent mirrors 14 when the array is operational.

An imaging device 10 may include an array 12 of millions of micro mirrors 14, which may be referred to as pixels, so as to produce a high definition image. Each of the mirrors 14 may be individually actuated to move between rest and active states, sometimes referred to as off and on states, so as to reflect light to a light dump (in the rest state) and so as to reflect light to a viewing region (in the active state), for example. Reliable and efficient movement of the micro mirrors 14 with a low power consumption would allow an robust imaging device 10 to be manufactured and operated at a low cost. The apparatus and method of the present disclosure provides a robust and low cost solution.

FIG. 2 is an isometric view of an individual micro mirror 14 of the array 12 of FIG. 1. in a rest position. Mirror 14 may include a reflective structure 20 that includes support regions 16 and which may be formed in the shape of a paddle or a “T”, and may be supported on support structures 22 that extend upwardly from a substrate 24. Support structures 22 and support regions 16 may define rotational axis 18 extending therethrough.

In FIG. 2 as shown, a portion of substrate 24 positioned directly below reflective structure 20 is shown for ease of illustration, and may be referred to as the footprint 26 of reflective structure 20 on substrate 24. A single substrate 24 may extend below and support each reflective structure 20 of array 12 (see FIG. 1). In the embodiment shown, the “rest” position of mirror 14 may refer to the position of mirror 14 when the plane 28 of the top surface 30 of reflective structure 20 is positioned parallel to the plane of substrate 24, i.e., reflective structure 20 is not tilted with respect to substrate 24 or support structures 22. In other embodiments this untilted position may be the “active” position.

Still referring to FIG. 2, micro mirror 14 may further include a bubble generation structure 32 and a latch structure 34 (shown in dash lines) positioned on substrate 24, opposite one another across mirror 14, and on opposite sides of rotational axis 18. In this embodiment, bubble generation structure 32 may be positioned between reflective structure 20 and substrate 24 and aligned with a first side region 36 of reflective structure 20. Similarly, latch structure 34 may be positioned between reflective structure 20 and substrate 24 and aligned with a second side region 38 of reflective structure 20.

FIG. 3 is an isometric view of the individual micro mirror 14 of FIG. 2. in an active position. In this active position of the embodiment shown, reflective structure 20 is tilted with respect to substrate 24 such that plane 28 of top surface 30 of reflective structure 20 defines an angle 40 in a range of approximately one to sixteen degrees, and approximately eight degrees. As will be understood by those skilled in the art, tilting of reflective structure 20 with respect to its rest position (see FIG. 2) will redirect light from a light dump (not shown), for example, to a viewing region (not shown) for defining a viewable image. In this tilted or active position, support structures 22 may remain stationary on substrate 24 and support regions 16 of reflective structure 20 may remain approximately stationary on support structures 22 such that the narrow regions 42 of support region 16 may bend or somewhat deform during tilting movement of reflective structure 20. Accordingly, it may be desirable to manufacture reflective structure 20 and, in particular, narrow regions 42 of support regions 16, of a bendable or somewhat flexible material.

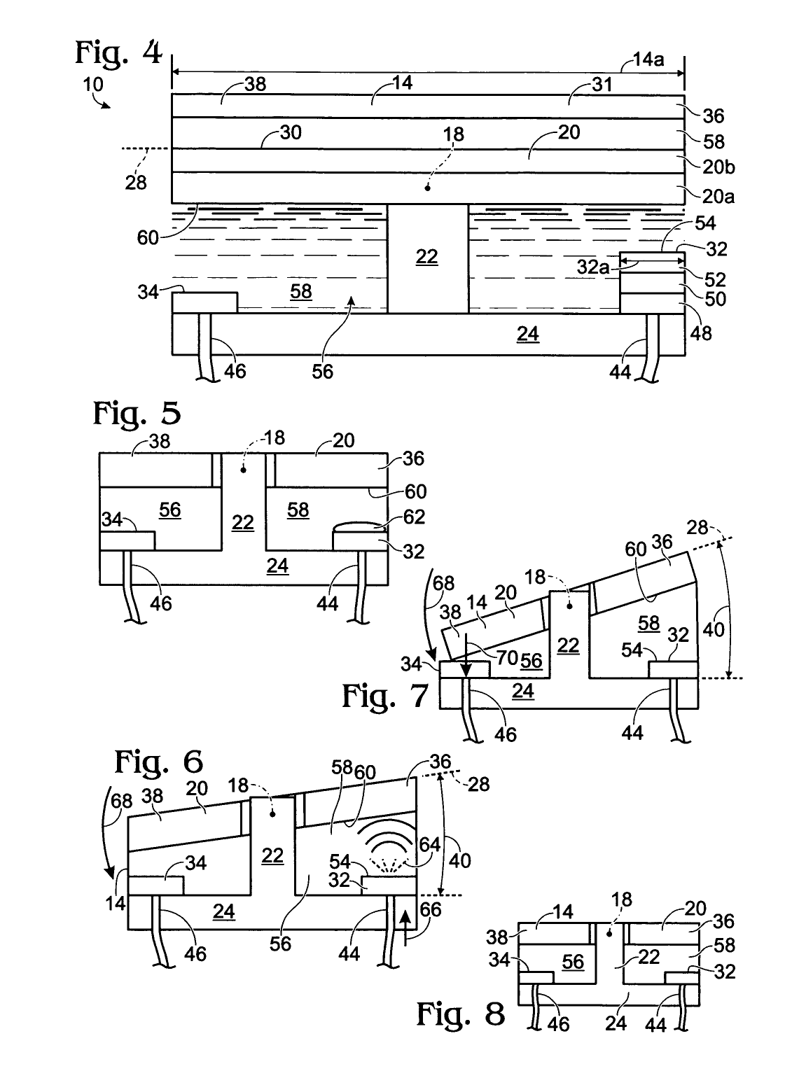

FIG. 4 is a side cross-sectional view of the individual micro mirror 14 of FIG. 2 taken along cross-sectional line 4-4. The multiple layers of mirror 14 may be manufactured utilizing standard mask and etch semiconductor processing techniques. In the particular embodiment shown substrate 24 may be manufactured of TEOS and may include vias 44 and 46 that allow contact through the substrate to bubble generation structure 32 and latch structure 34, respectively.

Bubble generation structure 32 may be manufactured of three layers including a first layer 48 of a resistor material, such as Tungsten Silicon Nitride (WSiN), a second layer 50 of a passivation material, such as Silicon Nitride (SiN), and a third layer 52 of a bubble generation material, such as Tantalum (Ta). Third layer 52 may define a top surface 54 which may be referred to as a cavitation surface or a cavitation plate for the generation of a bubble thereon (see FIG. 5). Latch structure 34 may be manufactured of a single layer of a conductor material, for example, Gold (Au). Support structures 16 (one support structure can be seen in this view) and reflective structure 20 may both be manufactured of any suitable applicable material that will withstand tilting movement and will support a reflective material on top surface 30. In the embodiment shown, reflective structure 20 includes a first layer 20a manufactured of a photo resist epoxy, such as Su8, and a second layer 20b manufactured of a reflective material, such as Aluminum (Al). Top surface 30 of reflective structure 20 may be the top surface of second reflective layer 20b. Support structures 16 may also be manufactured of a photo resist epoxy, namely Su8.

In one example embodiment, bubble generation structure 32 may have a width dimension 32a of approximately 10 to 15 micrometers and mirror 14 may have a width dimension 14a of approximately 20 to 30 micrometers.

In another embodiment, bubble generation structure 32 may include two layers, for example, layer 48 manufactured of Tungsten Silicon Nitride and layer 52 manufactured of Tantalum. Such an embodiment, which does not include a dielectric middle layer 50, may be utilized when liquid 58 is dielectric.

In still other embodiments, bubble generation structure 32 and latch structure 34 may be positioned in different locations and have different shapes and/or sizes than shown. In one particular embodiment, a first latch structure 34 may be positioned adjacent to second side region 38 of mirror 14 for example, and a second, independently operated latch structure 34 may be positioned adjacent to first side region 36 of mirror 14 for example, and adjacent to bubble generation structure 32, 1 so that mirror 14 may be latched in both the active and rest positions.

Still referring to FIG. 4, substrate 24 and reflective structure 20 define a cavity 56 therebetween. Cavity 56 may extend completely along array 12 (see FIG. 1) such the space between each individual mirror 14 and substrate 24 is a continuous open space and may not be completely enclosed for each individual mirror 14. In other embodiments, cavity 56 may be completely enclosed for each individual micro mirror 14. Cavity 56 may be filled with a fluid medium such as liquid 58, namely, water or Flourinert (Registered Trademark of 3M Company). Accordingly, liquid 58 may be in contact with the underside 60 of first side region 36 of reflective structure 20 and may be in contact with the top surface 54 of bubble generation structure 32. In one embodiment, liquid 58 may be retained within array 12 by a transparent top cover plate 31 positioned upwardly from top surface 30 of reflective structure 20. Top cover plate 31 may allow light transmission therethrough but may retain liquid 58 within array 12. Top cover plate 31 is shown in FIG. 4, but not the other figures, for ease of illustration.

FIG. 5 is a side cross-sectional view of a micro mirror 14 during bubble formation on bubble generation structure 32. To form a bubble 62 a voltage is applied to bubble generation structure 32 through via 44. The voltage causes formation of the gaseous bubble 62 on top surface 54 of bubble generation structure 32 within liquid 58. In one embodiment, a bubble 62 was generated in approximately two to three micro seconds with 15 volts applied to bubble generation structure 32. During formation of bubble 62, the growing bubble 62 may transfer inertial energy as well as pressure waves into liquid 58 which may cause first side region 36 of mirror 14 may move slightly upwardly away from bubble 62. Accordingly, growing bubble 62 may not contact mirror 14 but may nevertheless transfer energy to reflective structure 20 through liquid 58 such that first side region 36 of reflective structure 20 is moved slightly upwardly.

FIG. 6 is a side cross-sectional view of a micro mirror 14 during imparting of bubble energy to reflective structure 20 and movement of the reflective structure 20 to an active position. The term “bubble energy” may be used to describe the inertial energy and/or acoustic energy of bubble 62 that is transferred to liquid 58 and therethrough to micro mirror 14, without bubble 62 contacting reflective structure 20. As shown in FIG. 6, bubble 62 may grow to a size whereafter it collapses thereby imparting its bubble energy, shown schematically as arrows 64, to liquid 58 in the form of inertial energy and/or acoustic energy. Acoustic or bubble energy 64 is imparted to liquid 58 in first side region 36 of underside 60 of reflective structure 20. The energy 64 is then received on underside 60 of first side region 36 of reflective structure 20 and causes first side region 36 to move upwardly in a direction 66 such that reflective structure 20 rotates in a direction 68 about rotational axis 18 on support structures 16 (see FIG. 3) such that second side region 38 of reflective structure 20 moves to a position adjacent to latch structure 34. In this tilted position, the plane 28 of top surface 30 of reflective structure 20 may be positioned at angle 40 in a range of approximately twelve to fifteen degrees with respect to substrate 24. Collapse of bubble 62 (see FIG. 5) is believed to impart a relatively small amount of bubble energy to reflective structure 20 and cause a relatively small tilting movement of reflective structure 20 in direction 68 whereas collapse of bubble 62 is believed to impart a relatively large amount of bubble energy to reflective structure 20 and cause a relatively large tilting movement of reflective structure 20 in direction 68. In other words, the combined energy transfer phenomena of bubble growth (FIG. 5) and bubble collapse (FIG. 6) has been observed to tilt reflective structure 20 at angle 40 in a range of approximately twelve to fifteen degrees with respect to substrate 24, wherein the majority of the tilting movement is believed to be due to bubble energy transfer during and after bubble collapse.

FIG. 7 is a side cross-sectional view of a micro mirror 14 during latching of the mirror 14 to latch structure 34. In the embodiment shown, while reflective structure 20 is still in the tilted position (see FIG. 6) due to the application of bubble energy 64 within fluid medium 58, a voltage 70 may be applied to latch structure 34 through via 46. The voltage 70 applied at latch structure 34 may cause an electrostatic attraction between latch structure 34 and underside 60 in second side region 38 of reflective structure 20. This electrostatic attraction may cause further movement of second side region 38 toward latch structure 34 by further rotation in direction 68 of reflective structure 20 about rotational axis 18 until second side region 38 of reflective structure 20 contacts latch structure 34. During the time period that voltage 70 is applied at latch structure 34, reflective structure 20 may be latched or held with second side region 38 of reflective structure 20 in contact with latch structure 34. In the embodiment shown, the collapse of bubble 62 and the electrostatic attraction caused by voltage 70 may cause reflective structure 20 to rotate approximately twelve to fifteen degrees in direction 68 such that plane 28 of top surface 30 of reflective structure 20 may be positioned at an angle 40 of approximately twelve to fifteen degrees with respect to substrate 24. Reflective structure 20 may be grounded to facilitate the latching operation of latch structure 34.

FIG. 8 is a side cross-sectional view of a micro mirror 14 during release by latch device 34, i.e., stopping the application of voltage 70 thereto, and subsequent rotational or tilting movement of mirror 14 to a rest position. In this rest position reflective structure 20 is ready for the cycle to begin again wherein a bubble is formed, the bubble collapses, and the bubble energy, i.e., the inertial and/or acoustic energy generated by the explosive vaporization event, is imparted to reflective structure 20 to move it to the active position (see FIG. 7). In one example, a 5 micrometer thick Su8 pixel with a metal top surface was held in place with an even 4 volt potential with a stiffness of the hinge at less than 0.001 N/m. For stiffer structures it is believed that a slightly higher potential may be utilized to latch the mirror in place. Similarly, for less stiff structures, such as structures with smaller thicknesses and/or longer lengths, a smaller potential may be utilized to latch the mirror in place.

Accordingly, the present disclosure provides an apparatus and method for actuating structures in fluid wherein a bubble is formed on a cavitation plate, the bubble collapses and imparts its bubble energy to a fluid medium, and the fluid medium transfers the bubble energy to the structure so as to actuate or physically move the structure. Accordingly, the bubble that is generated does not physically contact and cause movement of the structure but instead the bubble energy is released when the bubble collapses and the transferred energy causes physical movement of the structure.

The bubble energy or acoustic actuation method of the present disclosure allows a low voltage to be utilized to actuate the structure yet provides a strong driving force to move the structure quickly. The strong driving force also makes the system more robust in that process and structure variations, such as the thicknesses and gaps of the structure and the amount of energy transferred, may have relatively large margins of error while still providing a functional device. Additionally, a low voltage may be utilized to latch the structure in the active position. Moreover, use of a fluid medium for transfer of the system energy provides a cooling system for the process and reduces stiction issues within the system.

In the particular embodiment of the present disclosure, a 100 kHz resonant frequency of the mirrors 14 between the rest and active positions was achieved in testing. Plus or minus 0.5 micrometers was an acceptable process margin during fabrication of test devices. The mirrors 14 were seen to move within 5 microseconds of firing (bubble creation), torsional deflection of the mirrors at angles of at least twelve degrees was observed, and stress test firings of 36 million sequential firings was observed with no degradation of reflective structure 20. At a 60 Hz refresh speed, for four colors (red, green, blue and white), 240 firings per second were achieved for each mirror 14.

Other variations and modifications of the concepts described herein may be utilized and fall within the scope of the claims below.

We claim:

1. A device, comprising:
a structure movably positioned above and spaced from a substrate; and
a bubble generation structure positioned between said substrate and said structure, said bubble generation structure structured for imparting a bubble energy to said structure to move said structure with respect to said substrate.

2. The device of claim 1 wherein said device comprises an imaging device and said structure comprises a micro imaging structure, said imaging device further comprising a substrate and a fluid medium positioned between said substrate and said micro imaging structure, wherein said bubble generation structure comprises a resistor in contact with said fluid medium.

3. The device of claim 2 wherein said resistor comprises a cavitation plate adapted for generating and then collapsing a gaseous bubble thereon.

4. The device of claim 3 wherein said cavitation plate comprises a layered structure including a first layer positioned on said substrate, a second layer positioned on said first layer, and a third layer positioned on said second layer.

5. The device of claim 4 wherein said first layer is manufactured of WSiN, said second layer is manufactured of SiN, and said third layer is manufactured of Ta.

6. The device of claim 1 further comprising a support positioned on a substrate, said structure movably positioned on said support.

7. The device of 6 wherein said structure and said support are both manufactured of an epoxy photoresist.

8. The device of claim 1 wherein said structure includes a reflective top surface positioned thereon.

9. The device of claim 1 further including a restraining device positioned between a substrate and said structure, said restraining device structured for temporarily restraining said structure from movement with respect to said substrate.

10. The device of claim 9 wherein said restraining structure is manufactured of a conductive material.

11. The device of claim 1 further comprising an array of structures, and corresponding bubble generation structures, movably positioned above and spaced from a substrate.

12. A method of actuating a structural component, comprising:
generating a gaseous bubble beneath a movable structural component; and
collapsing said gaseous bubble to impart a bubble energy from said bubble to said movable structural component to cause movement of said structural component structure from a rest position to an active position.

13. The method of claim 12 wherein said movable structural component returns to said rest position from said active position after dissipation of said bubble energy applied thereto.

14. The method of claim 13 wherein said movable structural component comprises a micromirror positioned within a fluid medium, and wherein said method further comprises generating gaseous bubbles in a sequential pattern so as to move said micromirror between said rest and active positions in according with said sequential pattern to form sequential images.

15. The method of claim 12 further comprising restraining for a time period said structural component in said active position after dissipation of said bubble energy, and thereafter releasing said structural component.

16. The method of claim 15 wherein said movable structural component returns to said rest position from said active position after release thereof.

17. The method of claim 12 further comprising:
generating a pattern of gaseous bubbles, each bubble generated beneath chosen ones of an array of movable structural components; and
collapsing said pattern of gaseous bubbles to impart a bubble energy from each said bubble to said chosen ones of said array of movable structural components to cause movement of each of said structural components from a rest position to an active position.

18. A method of manufacturing an imaging device, comprising:
manufacturing a substrate;
manufacturing a bubble generation surface on said substrate;
manufacturing a support on said substrate; and
manufacturing a micro imaging device on said support such that said micro imaging device is spaced from said substrate and such that said bubble generation surface is positioned between said substrate and said micro imaging device.

19. The method of claim 18 further comprising manufacturing an electrostatic latch device on said substrate such that said electrostatic latch device is positioned between said substrate and said micro imaging device.

20. The device of claim 18 further comprising manufacturing a pattern of supports and a corresponding pattern of bubble generation surfaces on said substrate, manufacturing a micro imaging device on each support of said pattern of supports, and enclosing said supports, bubble generation surfaces, and micro imaging devices within a fluid medium.
